(19) United States
(12) Patent Application Publication
(10) Pub. No.: US 2018/0037311 A1
(43) Pub. Date: Feb. 8, 2018

(54) Locking mechanism for unmanned aerial vehicle

(71) Applicant: Haoxiang Electric Energy (Kunshan) Co., Ltd., Kunshan (CN)

(72) Inventors: Yu Tian, Kunshan (CN); Wenyan Jiang, Kunshan (CN)

(73) Assignee: Haoxiaang Electric Energy (Kunshan) Co., Ltd,

(21) Appl. No.: 15/719,111

(22) Filed: Sep. 28, 2017

(30) Foreign Application Priority Data
Dec. 27, 2016 (CN) 201621450744.4

(51) Int. Cl. B64C 11/08; B64C 11/28

(52) U.S. Cl. CPC B64C 11/08; B64C 11/28; B64C 39/024

(57) ABSTRACT

A locking mechanism for unmanned aerial vehicle (UAV) is provided by the present invention, includes: a motor, a base, a blade and a locking component; wherein the base comprises a mounting groove for the blade inserting in; the locking component is configured to fixedly connect the base and a rotor of the motor by passing through the base and the blade; the blade is configured to rotate freely relative to the locking component in a range of angles. The locking component of the present invention is convenient for assembly and disassembly, with a light weight and a small structure.

### CROSS REFERENCE OF RELATED APPLICATION

The present application claims priority under 35 U.S.C. 119(a-d) to CN 201621450744.4, filed Dec. 27, 2016.

### BACKGROUND OF THE PRESENT INVENTION

### Field of Invention

The present invention relates to the technical field of unmanned aerial vehicle (UAV), and more particularly to a locking mechanism for UAV.

### Description of Related Arts

Unmanned aerial vehicle, UAV for short, is an unmanned flight vehicle manipulated by the remote-radio-control apparatus and the self-provided program control device. The UAV usually rotates in the air by a screw propeller to generate propulsive forces to accomplish the flight. In a locking manner of the current base, on one hand, the base is required to fix on the rotor of the motor, so as to be driven to rotate; on the other hand, the blade is required to be connected with the base, and a large amount of screws are required for fixing. This kind of connecting manner is complicated, the assembly and disassembly is not convenient, and the connectors increase the weight of the UAV arms.

### SUMMARY OF THE PRESENT INVENTION

A technical problem to be solved by the present invention is to provide a locking mechanism for an unmanned aerial vehicle (UAV) which is convenient for assembly and disassembly, with a light weight and a small structure.

Accordingly, in order to solve the problem mentioned above, the present invention provides a locking mechanism for an unmanned aerial vehicle (UAV), comprising: a motor, a base, a blade and a locking component;

wherein the base comprises a mounting groove for the blade inserting in;

the locking component is configured to fixedly connect the base and a rotor of the motor by passing through the base and the blade;

the blade is configured to rotate freely relative to the locking component in a range of angles.

According to a preferred embodiment of the present invention, the mounting groove comprises a first groove wall and a second groove wall relative to the first groove wall, a counterbore is provided on the first groove wall; a connecting hole is provided on the second groove wall; the locking component is configured to fixedly connect the base to the motor by passing through the counterbore, a though hole on the blade and the connecting hole in sequence.

According to a preferred embodiment of the present invention, the locking component is a step screw connector which comprises a threaded portion, a screw cap and a rod portion, the threaded portion is meshed with the rotor of the motor; the screw cap is disposed in the counterbore to fix the base; the rod portion is acted as a rotating shaft of the blade.

According to a preferred embodiment of the present invention, the step screw connector is a step screw.

According to a preferred embodiment of the present invention, the mounting groove is disposed on a side surface of the base, the counterbore is disposed on an upper groove wall of the mounting groove; the connecting hole is disposed on a lower groove wall of the mounting groove; a side wall of the mounting groove is configured to restrict rotating range of the blade.

According to a preferred embodiment of the present invention, a base cap is disposed on an end of the base which is near to the counterbore.

According to a preferred embodiment of the present invention, an intermediate shaft portion of the motor is the stator, and an around axis portion of the motor is the rotor, wherein the rotor is capable of driving the base to rotate.

According to a preferred embodiment of the present invention, the stator of the motor is connected with an arm of the UAV via a connector.

According to a preferred embodiment of the present invention, the connector is connected with the arm of the UAV via a non-axis portion; holes are disposed on the connector for reducing weight.

According to a preferred embodiment of the present invention, the blade comprises a left blade and a right blade; the mounting groove comprises a left mounting groove and a right mounting groove which are opposite to each other; wherein the left blade is provided in the left mounting groove via a first locking component; the right blade is provided in the right mounting groove via a second locking component.

By adopting the technical solutions mentioned above, the present invention has following beneficial effects compared with the conventional arts. On one hand, the locking component serves as a fixing component of the base to connect and fix the base and the rotor of the motor together; on the other hand, the locking component serves as a pivotal axis, in such a manner that the blade is capable of rotating around the locking component in the base; so that the locking component integrates a fixing function of the base and an axis function of the blade, so as to decrease amount of screws in base fixation and UAV weight and facilitate disassembly and assembly.

### BRIEF DESCRIPTION OF THE DRAWINGS

FIG. 1 is an exploded structural view of a locking mechanism for unmanned aerial vehicle according to a preferred embodiment of the present invention.

FIG. 2 is an exploded structural view of a locking mechanism for unmanned aerial vehicle according to another preferred embodiment of the present invention.

### REFERENCE NUMBERS IN THE FIGS

1—motor; 2—base; 3—blade; 4—step screw connector; 5—base cap; 6—connector; 11—rotor; 12—stator; 111—rotor threaded portion; 21—mounting groove; 22—counterbore; 23—connecting hole; 31—through hole; 41—threaded portion; 42—rod portion; 43—screw cap.

### DETAILED DESCRIPTION OF THE PREFERRED EMBODIMENT

These and other objectives, features, and advantages of the present invention will become apparent from the following detailed description, the accompanying drawings, and the appended claims.

One skilled in the art will understand that the embodiment of the present invention as shown in the drawings and described above is exemplary only and not intended to be limiting.

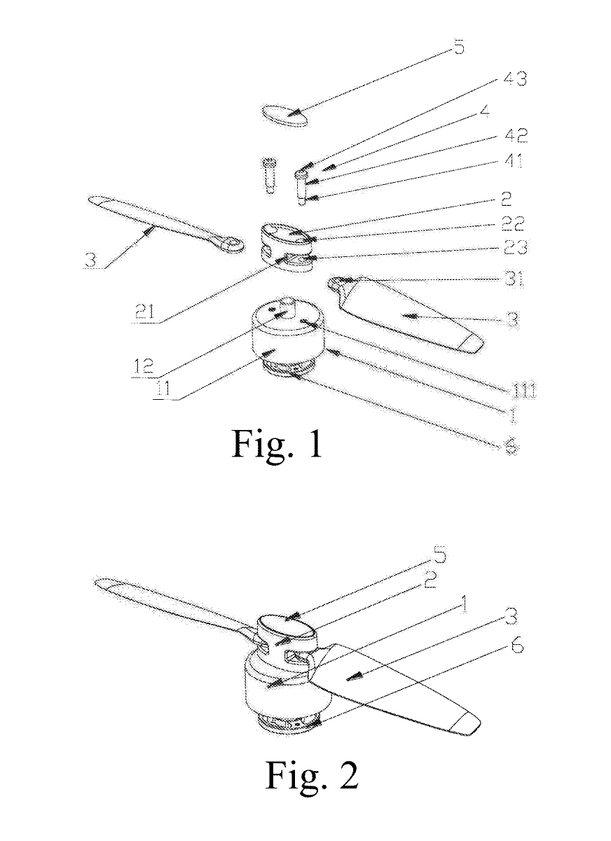

Referring to FIG. 1 and FIG. 2, according to a preferred embodiment of the present invention, a locking component for an unmanned aerial vehicle (UAV) comprises: a motor 1, a base 2, a blade 3 and a locking component.

The base 2 has at least one mounting groove 21 provided thereon, and the blade 3 is inserted in the mounting groove 21 of the base 2.

If the blade 3 is an all-in-one blade, an amount of the mounting groove 21 can be one. The mounting groove 21 is provided on a central part of the base 2. A connection part between the base 2 and the motor 1 is correspondingly provided on the central part. A central part of the blade 3 is installed corresponding to the central part of the base 2, in such a manner that the blade 3 is symmetrical to a center of the base 2.

If the blade 3 is two pieces of split blades, the amount of the mounting grooves 21 are correspondingly two. The two pieces of split blades are respectively provided on the mounting grooves 21. The mounting grooves 21 are symmetrically provided on the base 2. A center that the blade 3 pivots around the locking component is deviated from a rotating center of the base 2; i.e., two locking components are symmetrically installed by deviating from the rotating center of the base 2, in such a manner that the blade generates symmetrical centrifugal force during the rotating process of the base; and the two blades are in a straight line.

Of course, the amount and structure of the blade 3 is not limited to this. Accordingly, installation position between the blade 3 and the base 2 or the locking component can be provided according to requirements.

The locking component passes through the base 2 and the blade 3 to connect the base 2 and a rotor of the motor 1. The blade can rotate freely relative to the locking component in a range of angles. In other words, on one hand, the locking component serves as a fixing component of the base 2 to connect and fix the base 2 and the rotor of the motor 1 together; on the other hand, the locking component serves as a pivotal axis, in such a manner that the blade 3 is capable of rotating around the locking component in the base 2; so that the locking component integrates a fixing function of the base and an axis function of the blade, so as to decrease amount of screws in base fixation and UAV weight and facilitate disassembly and assembly.

There is no other element between the blade 3 and the base 2 except the locking component, and the blade 3 is capable of rotating relative to the base 2. While the blade 3 rotating relative to the base 2, a rotating angle is restricted by the mounting groove 21; and by restriction of the mounting groove 21, the base 2 is capable of driving the blade 3 to rotate. The blade 3 is not capable of rotating relative to the base 2 in 360 degrees, and is only capable of rotating in a certain range of angles; wherein a specific rotating angle range is not restricted and only determined according to requirements. In non-operating state, the blade 3 can be rotated to close arms of the UAV to be in a folded state, so as to facilitate storage of the UAV to prevent the blade from being damaged.

The motor 1 comprises a stator 12 and a rotor 11 and operation of the motor 1 is controlled by a motor control circuit. While in operation, the stator 12 is stationary, the rotor 11 rotates to drive the base 2 which is connected with the rotor 12 to rotate accordingly. Since the blade 3 is provided on the base 2, the blade 3 is driven to rotate as well. Pivoting can be performed between the blade 3 and the base 2. In the rotating process of the base 2, the blade performs a symmetric expansion under a centrifugal force for keeping balance.

According to a preferred embodiment of the present invention, for each mounting groove 21, a counterbore 22 is provided on a first groove wall of the mounting groove 21; a connecting hole 23 is provided on a second groove wall; wherein the first groove wall is opposite to the second groove wall. The locking component respectively passes through the counterbore 22, a through hole 31, a connecting hole 23 in sequence to connect and fix the base 2 and the motor 1. The blade 3 is not fixed by the locking component and capable of rotating around the the locking component.

According to a preferred embodiment of the present invention, the locking component is a step screw connector 4, and a threaded portion 41 is connected with a screw of the rotor 11 of the motor 1; a screw cap 43 of the step screw connector 4 is sank in the counterbore 22 to tightly press the first groove wall of the base 2 to fix the base 2; and a low end step portion of the step screw connector 4 can also be sank in the connecting hole 23, so as to tightly press the first groove wall of the base 2 further. A rod portion 42 of the step screw connector 4 is corresponding to a position of the blade 3 and serves as a rotating shaft of the blade 3. The step screw connector 4 can be embodied as a step screw, but is not limited to this, other step screw connectors are also applicable.

According to another preferred embodiment of the present invention, the mounting groove 21 is opened on a side surface of the base 2, a counterbore 22 is provided on the first groove wall (upper groove wall) of the mounting groove 21; a connecting hole 23 is provided on a second groove wall (low groove wall) of the mounting groove 21; wherein the blade 3 is provided between the up groove wall and the low groove wall and capable of rotating horizontally; a side wall of the mounting groove 21 is for restricting rotating range of the blade 3.

According to another preferred embodiment of the present invention, a base cap 5 is provided on an end that has the counterbore 22 of the base 2, so as to be more complete and beautiful and to prevent deposition of dust and water in the base 2 for anti-ageing, so as to facilitate cleaning.

According to another preferred embodiment of the present invention, an intermediate shaft portion of the motor 1 is the stator 12, and an around axis portion of the motor 1 is the rotor 11, wherein the rotor 11 is capable of driving the base to rotate. The rotor 11 on the around axis portion has large area, so as to provide a large surface to connect and fix the base 2, a force is more uniform and connection thereof is more steady and convenient.

According to another preferred embodiment of the present invention, the stator 12 of the motor 1 is connected with an arm of the UAV via a connector 6, in such a manner that the motor 1 and the base 2 are installed on the arm of the UAV. Specifically, threaded hole is provided on the connector 6, and the connector is fixed by screw joint.

Preferably, the connector 6 is connected with the arm of the UAV via a non-axis portion; an axis portion is connected with the stator 12, in such a manner that inserting into the axis portion for connecting in installation is not necessary, so as to make connection more convenient. Connection manner is not limited by this, the connector 6 can also connect the arm of the UAV on any other portion. Lighting holes are opened on the connector 6, wherein shapes, sizes and amounts thereof are all not limited as long as the connections are not affected, so as to make weight of the whole UAV lighter.

According to another preferred embodiment of the present invention, the blade 3 comprises a left blade and a right blade which are separated with each other. The mounting groove 21 of the base 2 comprises a left mounting groove and a right mounting groove; wherein the left blade is provided in the left mounting groove via a first locking component; the right blade is provided in the right mounting groove via a second locking component. The specific installation manner is identical to the preferred embodiment mentioned above. A sectional side view of the base 2 is, for instance, is a “ [symbol] ” shape.

It will thus be seen that the objects of the present invention have been fully and effectively accomplished. Its embodiments have been shown and en described for the purposes of illustrating the functional and structural principles of the present invention and is subject to change without departure from such principles. Therefore, this invention includes all modifications encompassed within the spirit and scope of the following claims.

What is claimed is:

1. A locking mechanism for an unmanned aerial vehicle (UAV), comprising: a motor, a base, a blade and a locking component;
wherein the base comprises a mounting groove for the blade inserting in;
the locking component is configured to fixedly connect the base and a rotor of the motor by passing through the base and the blade;
the blade is configured to rotate freely relative to the locking component in a range of angles.

2. The locking mechanism for the UAV, as recited in claim 1, wherein the mounting groove comprises a first groove wall and a second groove wall relative to the first groove wall, a counterbore is provided on the first groove wall; a connecting hole is provided on the second groove wall; the locking component s configured to fixedly connect the base to the motor by passing through the counterbore, a though hole on the blade and the connecting hole in sequence.

3. The locking mechanism for UAV, as recited in claim 2, wherein the locking component is a step screw connector which comprises a threaded portion, a screw cap and a rod portion, the threaded portion is meshed with the rotor of the motor; the screw cap is disposed in the counterbore to fix the base; the rod portion is acted as a rotating shaft of the blade.

4. The locking mechanism for the UAV, as recited in claim 3, wherein the step screw connector is a step screw.

5. The locking mechanism for the UAV, as recited in claim 2, wherein the mounting groove is disposed on a side surface of the base, the counterbore is disposed on an upper groove wall of the mounting groove; the connecting hole is disposed on a lower groove wall of the mounting groove; a side wall of the mounting groove is configured to restrict rotating range of the blade.

6. The locking mechanism for the UAV, as recited in claim 2, wherein a base cap is disposed on an end of the base which is near to the counterbore.

7. The locking mechanism for the UAV, as recited in claim 1, wherein an intermediate shaft portion of the motor is the stator, and an around axis portion of the motor is the rotor, wherein the rotor is capable of driving the base to rotate.

8. The locking mechanism for the UAV, as recited in claim 7, wherein the stator of the motor is connected with an arm of the UAV via a connector.

9. The locking mechanism for the UAV, as recited in claim 8, wherein the connector is connected with the arm of the UAV via a non-axis portion; holes are disposed on the connector for reducing weight.

10. The locking mechanism for the UAV, as recited in claim 1, wherein the blade comprises a left blade and a right blade; the mounting groove comprises a left mounting groove and a right mounting groove which are opposite to each other; wherein the left blade is provided in the left mounting groove via a first locking component; the right blade is provided in the right mounting groove via a second locking component.
